(19) United States
(12) Patent Application Publication
(10) Pub. No.: US 2022/0126127 A1
(43) Pub. Date: Apr. 28, 2022

(54) SYMMETRIC-PLEAT FLAT MASK WITH AN EXPRESSION WINDOW, AND A MANUFACTURING METHOD AND PRODUCTION EQUIPMENT THEREOF

(71) Applicant: TAIWAN COMFORT CHAMP MANUFACTURING CO., LTD., Taoyuan City (TW)

(72) Inventor: Yung-Chih CHEN, Taoyuan City (TW)

(21) Appl. No.: 17/146,949

(22) Filed: Jan. 12, 2021

(30) Foreign Application Priority Data
Oct. 22, 2020 (TW) 109136718

(51) Int. Cl. A62B 18/02; A41D 13/11; A41H 43/04; A62B 18/08

(52) U.S. Cl. CPC A62B 18/025; A41D 13/1115; A62B 7/10; A62B 18/084; A41H 43/04

(57) ABSTRACT

A symmetric-pleat flat mask with an expression window, and a manufacturing method and production equipment thereof, are disclosed. The present invention is a flat mask after being collected. The flat mask is provided with a flat body, and is replaceably combined with a flexible refractive diaphragm at a location corresponding to a user's mouth while the user is wearing the flat mask, so that an expression of the user's mouth can be seen from outside. In addition, two side surfaces on the pleats that are symmetric upward and downward are planned obliquely with a contour line, respectively. The pleats, along with the flat body, are unfolded to construct a three-dimensional sheathing shelf, thereby improving the shielding effect.

### BACKGROUND OF THE INVENTION

### a) Field of the Invention

The present invention relates to a symmetric-pleat flat mask with an expression window, and a manufacturing method and production equipment thereof.

### b) Description of the Prior Art

A flat mask refers generally to a mask in a flat rectangle formed after being folded. Its structure includes a mask body that is laterally folded with plural layers of pleats from top to bottom. After being unfolded upward and downward, the plural layers of pleats are expanded longitudinally, forming a shielding surface to cover the nose and mouth and to filter air. As the mask body is an all-cover shield, the expression of a user's mouth cannot be seen from outside, and while the user is wearing the mask, the periphery of the mask body will not be easily attached to the curve on the face skin tightly.

### SUMMARY OF THE INVENTION

A primary object of the present invention is to disclose a symmetric-pleat flat mask with an expression window, and a manufacturing method and production equipment thereof; wherein a flat mask after being collected is provided with a flat body, and a center of the flat mask area is replaceably combined with a flexible refractive diaphragm, so that the expression of a user's mouth can be seen from outside. In addition, two side surfaces on the pleats that are symmetric upward and downward are planned respectively with a contour line. By the linking of an oblique traction force of the contour line with a tension of the flat body, the pleats can be unfolded to construct a three-dimensional sheathing shelf with a closed contour line, thereby improving an adhesive force of the periphery of the mask to the skin surface while the user is wearing the mask.

A second object of the present invention is to disclose a symmetric-pleat flat mask with an expression window, and a manufacturing method and production equipment thereof. The two vertically symmetric pleats are provided respectively with an inner pleat and an outer pleat, wherein the inner pleat and the outer pleat are connected together through an inner pleat base line and an outer pleat base line, and are folded on a skin-friendly side of the flat body after being collected.

A third object of the present invention is to disclose a symmetric-pleat flat mask with an expression window, and a manufacturing method and production equipment thereof. As the upper and lower structures of the flat mask are symmetric, a plastic cleat can be laterally combined at a place in approximation to a sideline of one outer pleat.

A fourth object of the present invention is to disclose a symmetric-pleat flat mask with an expression window, and a manufacturing method and production equipment thereof. By using an overlapped feeding operation to execute sequentially an edge banding and hole making operation, a film fixation operation, a wing-side folding operation, a contour sewing operation, a cropping operation, a stringing operation, and a side sealing operation, a continuous and coherent manufacturing is formed, which provides fast production in compliance with the manufacturing and every installation work required by all operations.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a flat mask, according to the present invention.

FIG. 2 shows a flow diagram of a manufacturing process, according to the present invention.

FIG. 3 shows a schematic view of a sequence of equipment used by the present invention.

FIG. 4 shows a schematic view of opening a shaped hole, according to the present invention.

FIG. 5 shows a schematic view of combining with a refractive diaphragm, according to the present invention.

FIG. 6 shows a schematic view of a process of folding a pleat, according to the present invention.

FIG. 7 shows a side view of completing the pleat, according to the present invention.

FIG. 8 shows a schematic view that an overlapped feeding operation is executing a lead-in operation, according to the present invention.

FIG. 9 shows a schematic view of combining with a plastic cleat, according to the present invention.

FIG. 10 shows a schematic view of the flat mask after being unfolded, according to the present invention.

FIG. 11 shows a cutaway side view of FIG. 10, according to the present invention.

### DETAILED DESCRIPTION OF THE PREFERRED EMBODIMENTS

The present invention discloses a symmetric-pleat flat mask with an expression window, and a manufacturing method and production equipment thereof; wherein, a flat mask is provided after being collected. The flat mask is a rectangular flat body, a center of the breadth of flat body corresponds to a user's mouth while the user is wearing the flat mask, and is replaceably combined with a flexible refractive diaphragm, allowing the expression of mouth to be seen from outside. Furthermore, two sides of the pleats are obliquely planned with a contour line. After being unfolded, the pleats construct a three-dimensional sheathing shelf, which increases the tightness in shielding of the mask and improves the production matters.

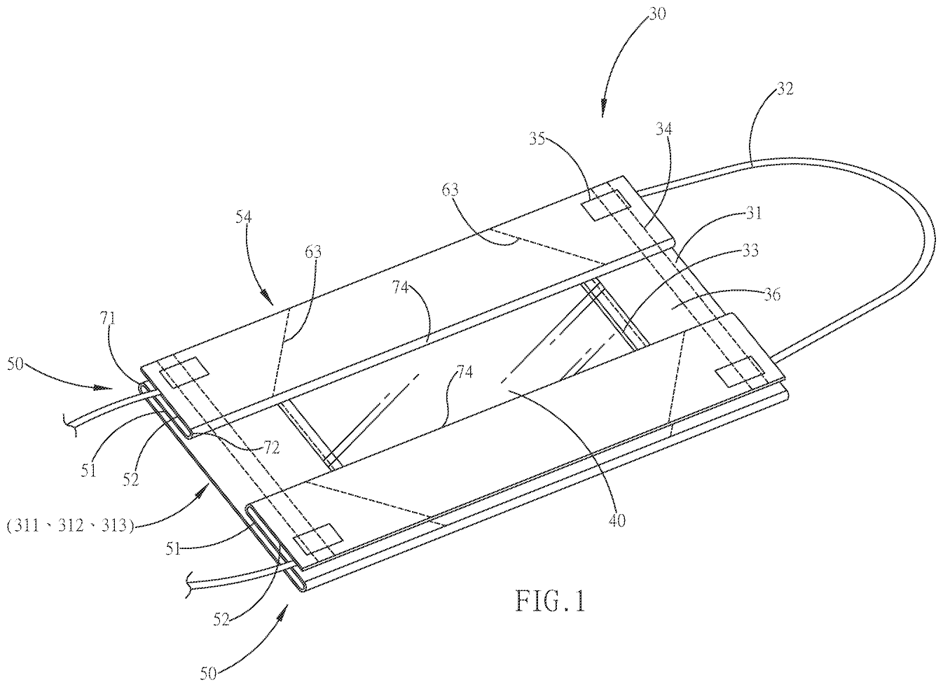

Firstly, referring to FIG. 1, a flat mask 30 provided by the present invention forms into a flat object after being folded, and includes a rectangular flat body 31. A center of the flat body 31 (ready for corresponding to a user's mouth) is provided with a shaped hole 33 that is longitudinally parallel to the flat body 31. The shaped hole 33 is surrogated by a refractive diaphragm 40. An upper and lower side of the flat body 31 is combined symmetrically with pleats 50 that are overlapped on a skin-friendly side 36 upward and downward. An inner pleat 51 and an outer pleat 52 provided by the pleat 50 are defined by an inner pleat base line 71 and an outer pleat base line 72, and are overlapped on an upper and lower side of the skin-friendly side 36 of the flat body 31. In addition, a provided inner sideline 74 crosses into the area of the refractive diaphragm 40.

The two pleats 50 are folded on the skin-friendly side 36, and a side surface 54 of each pleat 50 is provided with an oblique contour line 63 that is indented toward a center longitudinally.

The flat body 31 includes the pleats 50, and is formed by stacking an outer shielding layer 311, an intermediate layer 312 and an inner lining layer 313. Two sides of the flat body 31 are combined respectively with an elastically closed ear-hook element 32, and two ends of the ear-hook element 32 are combined at an upper and lower corner on two sides of the flat body 31 through a side sewing line 34 or a combining point 35.

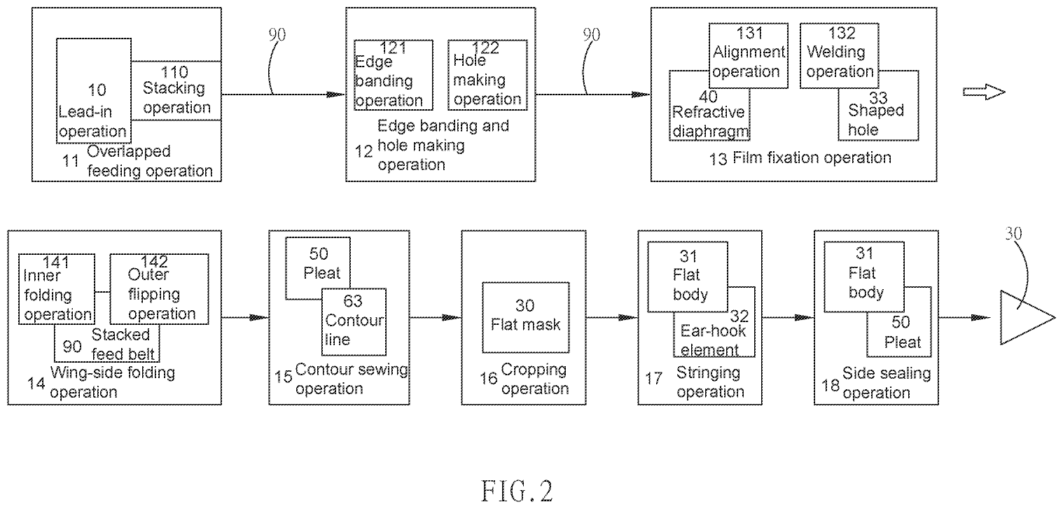

Please refer to FIG. 2 (along with FIG. 1) for the manufacturing method of the flat mask 30, according to the present invention. According to the operation line of manufacturing, an overlapped feeding operation 11 is executed. The overlapped feeding operation 11 feeds out a stacked feed belt 90 through a stacking operation 110, and then an edge banding operation 121 and a hole making operation 122 are conducted to the stacked feed belt 90 through an edge banding and hole making operation 12. Following the above mentioned edge banding and hole making operation 12, a film fixation operation 13 is executed. After extracting the refractive diaphragm 40, an alignment operation 131 is performed to the shaped hole 33 that is opened by the stacked feed belt 90; whereas, the periphery of the refractive diaphragm 40 is combined flat with the shaped hole 33 through a welding operation 132. Next, to the stacked feed belt 90 that is accomplished in the previous step, a wing-side folding operation 14 is conducted, wherein an inner folding operation 141 and an outer flipping operation 142 are executed. After that, a cropping operation 16 is conducted to extract the required length of the flat mask 30. Next, a stringing operation 17 is executed, connecting the ear-hook element 32 at a side corner of the flat body 31. Finally, a side sealing operation 18 is executed to sew the sidelines on the peripheries of the flat body 31 and the pleats 50, thereby accomplishing a complete flat mask 30.

Before the cropping operation 16, a contour sewing operation 15 is executed, sewing the oblique contour lines 63 on two sides surface 54 of the pleats 50. In addition, the contour sewing operation 15 and the cropping operation 16 can be combined into a same process.

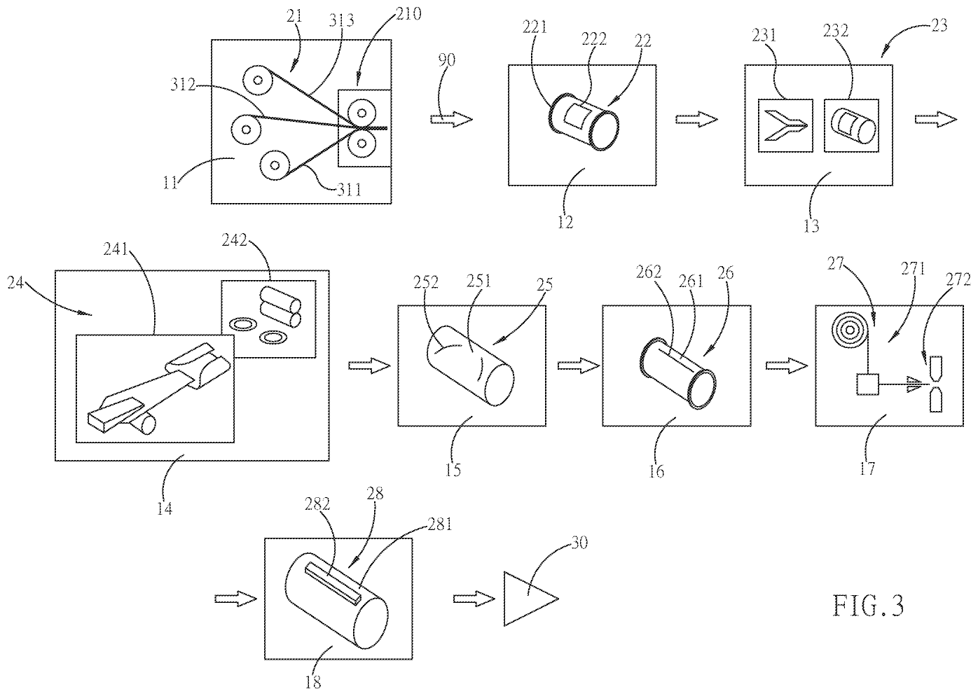

Referring to FIG. 3, corresponding to the manufacturing steps along the operation line, the equipment used by the present invention include sequentially the following devices. An overlapped feeding device 21 is provided corresponding to the overlapped feeding operation 11, the overlapped feeding device 21 allocates the outer shielding layer 311, the intermediate layer 312 and the inner lining layer 313, the stacked feed belt 90 is stacked by a stacking device 210 and is then fed out to the next operation. An edge banding and hole making device 22 is provided corresponding to the edge banding and hole making operation 12. The edge banding and hole making device 22 is a roller-shaped forming wheel, a center on the surface of the forming wheel is provided with a forming knife 222, and a front and rear end of the edge banding and hole making device 22 are provided respectively with a welding tread 221. A film fixation device 23 is provided corresponding to the film fixation operation 13. The film fixation device 23 is provided sequentially with a delivery mechanism 231 and a hot working frame 232. A wing-side folding device 24 is provided corresponding to the wing-side folding operation 14. The wing-side folding device 24 is in turn provided with an inner folding mechanism 241 and an outer flipping mechanism 242. A cropping device 26 is provided corresponding to the cropping operation 16. The cropping device 26 is a forming wheel 261, and the surface of the forming wheel 261 is longitudinally provided with a cutting edge 262. A stringing device 27 is provided corresponding to the stringing operation 17. The stringing device 27 is provided sequentially with a pinch mechanism 271, and a rear section of the pinch mechanism 271 is provided with a welding unit 272 subsidiarily. A side sealing device 28 is provided corresponding to the side sealing operation 18. The side sealing device 28 is formed by a forming wheel 281, and the surface of the forming wheel 281 is longitudinally provided with a hot working ridge 282. In addition, before the cropping device 26, a contour sewing device 25 can be provided corresponding to the contour sewing operation 15. The contour sewing device 25 is provided with a constant-speed forming wheel 251. A left and right surface of the constant-speed forming wheel 251 are symmetrically provided with a hot working ridge 252.

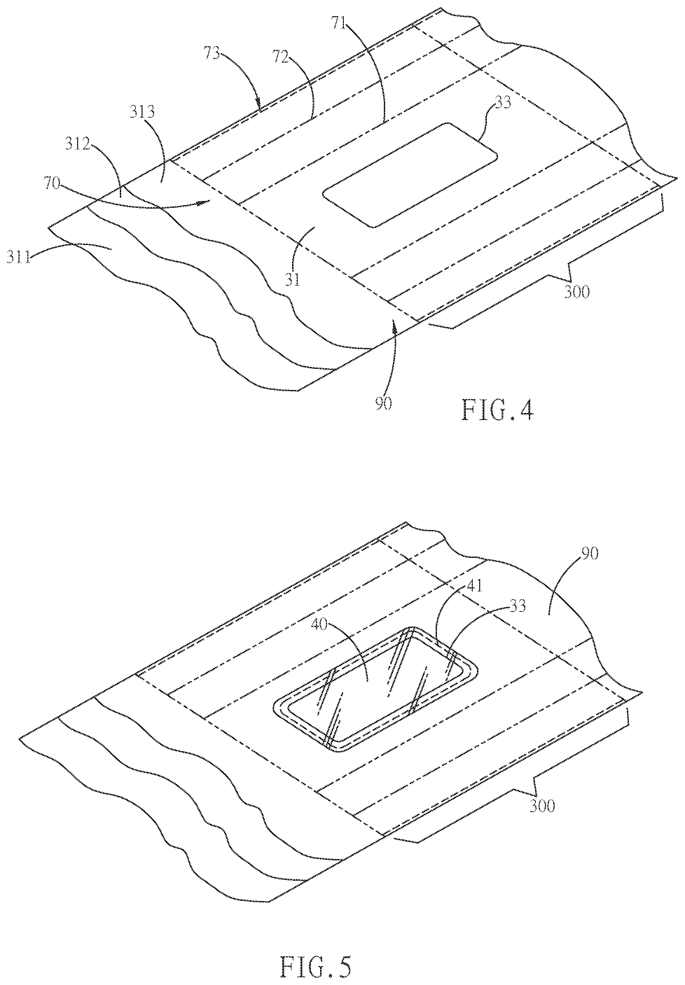

Please refer to FIGS. 4 to 7, along with FIGS. 1 to 3, for the change in material processing of the present invention. Firstly, FIG. 4 shows the type of processing of the edge banding and hole making operation 12. By the outcome of the overlapped feeding operation 11, the stacked feed belt 90 is fed out. The stacked feed belt 90 is formed by overlapping the outer shielding layer 311, the intermediate layer 312, and the inner lining layer 313. In a pre-determined region 300 to be planned, a center of the breadth that is expected to form the flat body 31 is opened with a shaped hole 33 longitudinally parallel to the stacked feed belt 90. Whereas, two sides of the stacked feed belt 90 define the inner pleat base lines 71, the outer pleat base lines 72 and sidelines 73, through a set of planning line 70. In the process, the sidelines 73 are sewn by the welding treads 221 provided by the edge banding and hole making device 22, and the shaped hole 33 is opened by the forming knife 222.

Referring to FIG. 5 (along with FIGS. 1 to 3), by the film fixation device 23 used in the film fixation operation 13, the stacked feed belt 90 is received, and the refractive diaphragm 40 is aligned and attached to the shaped hole 33 at the pre-determined region 300. First of all, the delivery mechanism 231 of the film fixation device 23 extracts the refractive diaphragm 40 and aligns the refractive diaphragm 40 with the shaped hole 33. Next, a peripheral sewing line 41 is formed by the welding operation of the hot working frame 232, allowing the refractive diaphragm 40 to be tightly combined flat with the shaped hole 33.

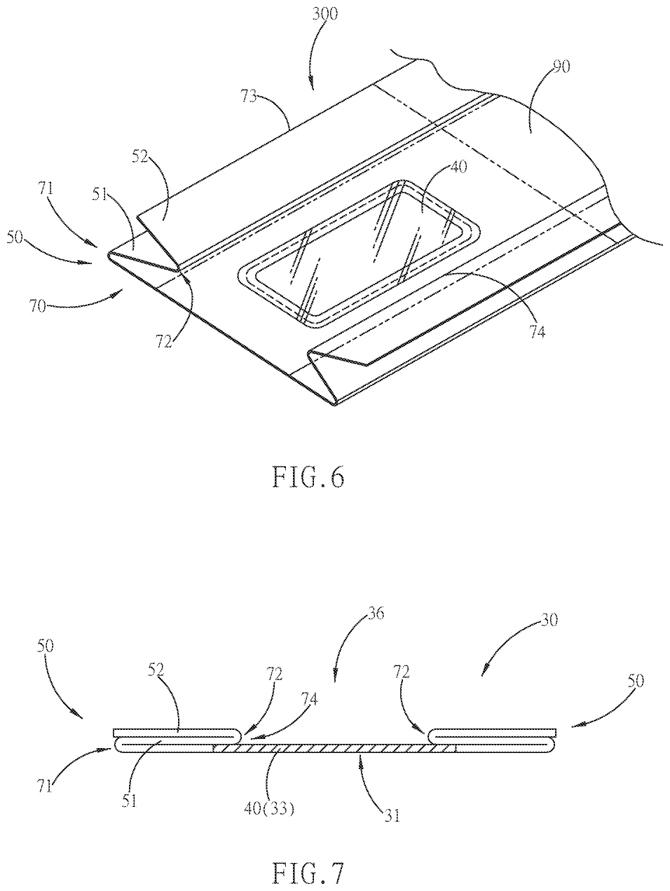

Referring to FIG. 6 (along with FIGS. 1 to 3), after the stacked feed belt 90 accomplishes the attachment of the refractive diaphragm 40, the wing-side folding operation 14 is conducted to fold symmetrically the pleats 50 on two sides of the stacked feed belt 90. The pleats 50 are defined by the planning line 70, and are folded inward to form the inner pleats 51 through the inner pleat base lines 71. The inner pleats 51 are folded outward to from the outer pleats 52 through the outer pleat base lines 72. The sidelines 73 and the inner pleat base lines 71 are overlapped. After being folded, the outer pleat base lines 72 (inner sidelines 74) cross into the area of refractive diaphragm 40. The folding of the inner pleat 51 is executed by the inner folding mechanism 241 provided by the wing-side folding device 24, and then the outer pleat 52 is folded by the provided outer flipping mechanism 242. The provided inner folding mechanism 241 and outer flipping mechanism 242 can be an ordinary guide plate and support structure for simplicity.

Referring to FIG. 7 (along with FIGS. 1 to 3), the folded and upward and downward symmetric pleats 50 on the flat mask 30 are defined respectively by the outer pleat base line 72. The formed outer pleat base line 72 (inner sideline 74) enters into the area space of the refractive diaphragm 40 (shaped hole 33), the inner pleat 51 and the outer pleat 52 are defined and overlapped into a stack by the inner pleat base line 71, and are folded on the skin-friendly side 36.

The stacked feed belt 90 accomplished after the folding in the abovementioned wing-side folding operation 14, is next conducted with the contour sewing operation 15 (contour sewing device 25), the cropping operation 16 (cropping device 26), the stringing operation 17 (stringing device 27), and the side sealing operation 18 (side sealing device 28) in FIG. 2 and FIG. 3, to complete the flat mask 30 (as the type in FIG. 1). The contour sewing operation 15 and the cropping operation 16 can be executed synchronously, whereas the cropping device 26 can be combined with the contour sewing device 25.

After accomplishing the contour sewing operation 15, a welded contour line 63 is formed along a corner side surface 54 of the pleat 50. The contour line 63 faces the entire welded pleat 50 and the flat body 31 to fix the stack.

The stringing operation 17 and the side sealing operation 18 belong to the ordinary mechanism and design of lead-wire introduction and hot-melt edge banding, which will not be described further.

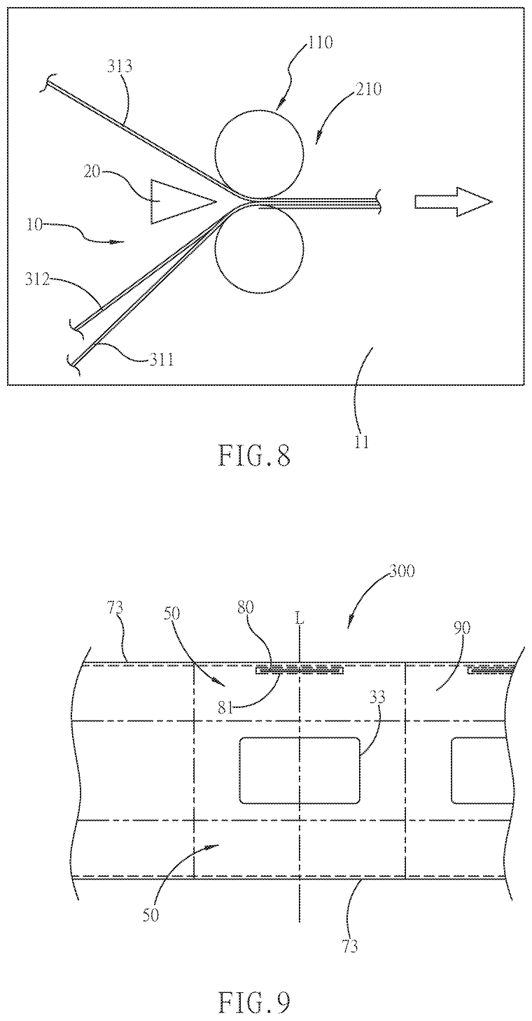

Referring to FIG. 8 and FIG. 9, in the execution of overlapped feeding operation 11, the outer shielding layer 311, the intermediate layer 312, and the inner lining layer 313 are disposed with respect to one another by an included angle, before the stacking operation 110. A lead-in operation 10 is executed within one included angle, wherein a long strip of plastic cleat 80 is fed in parallel to the operation line from a lead-in device 20 at the position of included angle. The plastic cleat 80 is sewn with the sideline 73 through a sewing line 81, its linear direction is parallel to the sideline 73, the position of combination is close to the edge of sideline 73, and a center point is aligned exactly to the center of shaped hole 33 (i.e., the location of longitudinal line L).

The pleat 50 is expected to be formed on two sides of the stacked feed belt 90, and the shaped hole 33 is disposed in a center of the pre-determined region 300. As the two sides of the stacked feed belt 90 are symmetric in size, the plastic cleat 80 can be selectively close to a side of one sideline 73 or close to the two sidelines 73 simultaneously. The plastic cleats 80 are applied to a user's nose bridge and jaw, and by tuning the two plastic cleats 80, the pleat 50 is adjusted to be attached onto a user's skin curve more tightly.

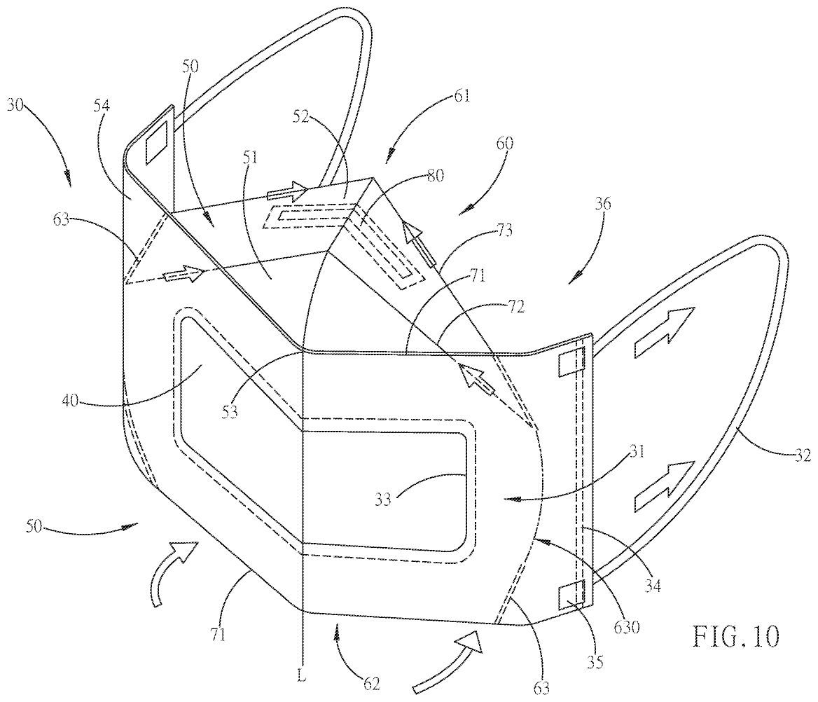

Referring to FIG. 10, it shows the structure of flat mask 30 after being unfolded. The flat body 31 is provided in a center with the refractive diaphragm 40 along the longitudinal line L, and two sides of the flat mask 30 are connected with the ear-hook element 32 for wearing the flat mask 30 on the user's auricles. Two pleats 50 are connected upward, downward, and symmetrically through the inner pleat base line 71, and the entire flat mask 30 is unfolded to concave into a sheathing shelf 60 on the skin-friendly side 36. The sheathing shelf 60 can be covered on the skin curve of the user's nose bridge and jaw (due to the limitation of angle in the drawing, only the upper pleat 50 is shown in FIG. 10, whereas as the lower pleat 50 is symmetric, its drawing is omitted.)

At the edge close to the sideline 73 of the pleat 50, a plastic cleat 80 is laterally disposed in the center. The plastic cleat 80 can be adjusted, so that the inner surface on that part of the plastic cleat 80 can be more tightly attached with the three-dimensional curve of the user's nose bridge. The plastic cleat 80 can be implemented on an edge of one pleat 50, or the edges of upper and lower pleat 50.

The pleat 50 is constructed by an inner pleat 51 that is connected through the inner pleat base line 71, and an outer pleat 52 that is connected with the inner pleat 51 through an outer pleat base line 72. Referring to FIG. 1, on a left and right side of the formed pleat 50 and at the four corner sides surface 54 of the overlapped flat body 31, a contour line 63 is implemented upward and downward, and is indented obliquely toward the center of longitudinal line L. While the user is wearing the flat mask 30, the contour line 63 is connected linearly with the sideline 73 through the connected flat body 31, which constructs a virtual closed contour 630. A center location of the flat body 31 that is aligned exactly to the longitudinal line L is connected with a center line of the pleat 50 through a connecting point 53.

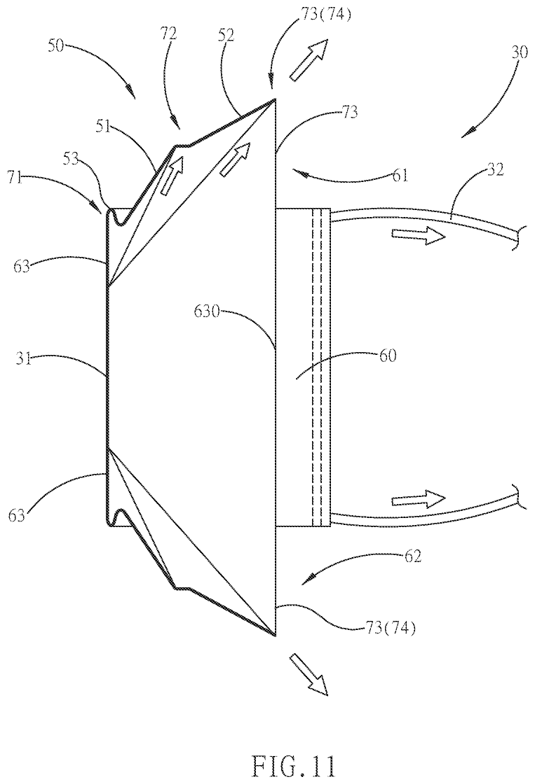

Referring to FIG. 11, while the user is wearing the flat mask 30, the sidelines 73 are unfolded upward and downward. The ear-hook element 32 is pulled backward, and the body of flat mask 30 is attached on the periphery of the user's nose and mouth by the extraction function at a front end and a rear end of the contour line 63. Therefore, a flat closed contour 630 is formed. The inner space of the closed contour 630 is formed with a sheathing shelf 60 by the inner surfaces of flat body 31, inner pleat 51 and outer pleat 52. By the wearing and pulling of ear-hook element 32, the closed contour 630 can be attached on the skin surface of the user's nose bridge and jaw, thereby increasing the regional tightness. The sheathing shelf 60 can be defined to include a top shelf side 61 and a bottom shelf side 62. The upper pleat 50 is unfolded to form the top shelf side 61, and the lower pleat 50 is unfolded to form the bottom shelf side 62. The inner surfaces of top shelf side 61, bottom shelf side 62 and flat body 31 construct the sheathing shelf 60.

The flat body 31 is symmetrically provided with the upper and lower pleat 50, and the contour line 63. After pulling out the upper and lower sideline 73, the pleats 50 are expanded symmetrically, forming a sheathing shelf 60 that is symmetric upward and downward. The closed contour 630 formed by the upper and lower sidelines 73 on the sheathing shelf 60 constitutes a virtual frame, which maintains the inner space of the sheathing shelf 60 and improves the shielding effect when the user is wearing the flat mask 30.

The abovementioned pleat 50 is basically formed by connecting the inner pleat 51 with the outer pleat 52. If the elasticity of material suffices, the pleat 50 can be a single sheet, i.e., the inner pleat 51 and the outer pleat 52 are a single-sheet structure that is connected on an opposite side of the flat body 31 through the inner pleat base line 71, with a sideline 73 being disposed outside.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A symmetric-pleat flat mask with an expression window, being a flat mask after being collected, and being provided with a flat body that is replaceably combined with a flexible refractive diaphragm at a location corresponding to a user's mouth, comprising
a rectangular flat body formed by stacking plural layers, with a center of the breadth of the flat body being opened with a long strip of shaped hole that is longitudinally parallel to the flat body;
a flexible refractive diaphragm that is larger than the shaped hole, with the refractive diaphragm being tightly attached to the periphery of shaped hole by a peripheral sewing line;
two symmetric pleats that are connected laterally from top to bottom of the flat body through an inner pleat base line, with the pleats being overlapped on a skin-friendly side of the flat body after being folded, a provided inner sideline crossing into one side on an inner surface of the refractive diaphragm, a left and right vertical end of the pleat being sewn at a sideline of the flat body respectively; and
two elastically closed ear-hook elements, with provided free ends thereof being combined respectively at an upper and lower corner location on a side of the flat body.

2. The symmetric-pleat flat mask with an expression window, according to claim 1, wherein an upper and a lower pleat are provided respectively with an inner pleat and an outer pleat, the inner pleat is connected on an opposite side of the flat body through the inner pleat base line, the outer pleat is connected with the inner pleat through an outer pleat base line, the inner pleat and the outer pleat are folded on the skin-friendly side of the flat body according to the definition of the inner pleat base line and the outer pleat base line, and the inner sideline formed by the outer pleat base line crosses into a side on the inner surface of refractive diaphragm.

3. The symmetric-pleat flat mask with an expression window, according to claim 1, wherein a left and right side of the pleat are formed respectively with a contour line that is indented obliquely toward a longitudinal line from the flat body, and the contour line is linearly connected through the breadth of flat body and the sideline, thereby constituting a closed contour.

4. The symmetric-pleat flat mask with an expression window, according to claim 1, wherein a center location on an outer side of one or two pleats is combined with a plastic cleat.

5. A manufacturing method of a symmetric-pleat flat mask with an expression window, comprising
an overlapped feeding operation, feeding out a stacked feed belt along an operation line through a stacking operation;
an edge banding and hole making operation, executing an edge banding operation on two overlapped sides of the overlapped feed belt, and executing a hole making operation to the shaped hole at a center location of the flat body that is expected to be formed in a planned pre-determined region;
a film fixation operation, extracting the refractive diaphragm and executing an alignment operation to the shaped hole, followed by conducting a welding operation to the periphery of refractive diaphragm;
a wing-side folding operation, conducting an inner folding operation and an outer flipping operation sequentially to two sides of the stacked feed belt, according to the direction of operation line;
a cropping operation, extracting laterally a semi-product of the flat mask according to the required length of product, perpendicular to the operation line;
a stringing operation, combining the two ear-hook elements on a cropping edge of the semi-product; and
a side sealing operation, sealing the cropping edge by hot working.

6. The manufacturing method of the symmetric-pleat flat mask with an expression window, according to claim 5, wherein before executing the cropping operation or conducting simultaneously with the cropping operation, a contour sewing operation is executed.

7. The manufacturing method of the symmetric-pleat flat mask with an expression window, according to claim 5, wherein before conducting the stacking operation of the overlapped feeding operation, a lead-in operation of a plastic cleat is executed at any included angle before overlapping an outer shielding layer, an intermediate layer, and an inner lining layer.

8. A production equipment of a symmetric-pleat flat mask with an expression window, comprising following devices according to the sequential arrangement of operation line:
an overlapped feeding operation, with an output end thereof being provided with a stacking device;
an edge banding and hole making device, which is a forming wheel, with two ends thereof being provided respectively with a welding tread, and a center of the welding tread being provided with a forming knife;
a film fixation device, which is sequentially provided with a delivery mechanism and a hot working frame;
a wing-side folding device, which is sequentially provided with an inner folding mechanism and an outer flipping mechanism;
a cropping device, which is a forming wheel, with a surface of the forming wheel being longitudinally provided with a cutting edge;
a stringing device, which is provided with a pinch mechanism; and
a side sealing device, which is a forming wheel, with a surface of the forming wheel being longitudinally provided with a hot working ridge.

9. The production equipment of the symmetric-pleat flat mask with an expression window, according to claim 8, wherein a rear end of the pinch mechanism provided by the stringing device is provided with a welding unit.

10. The production equipment of the symmetric-pleat flat mask with an expression window, according to claim 8, wherein a contour sewing device is disposed between the wing-side folding device and the cropping device.

11. The production equipment of the symmetric-pleat flat mask with an expression window, according to claim 10, wherein the contour sewing device is a constant-speed forming wheel, and a tread thereof is provided with a hot working ridge.

12. The production equipment of the symmetric-pleat flat mask with an expression window, according to claim 8, wherein the contour sewing device is a constant-speed forming wheel, and a front and rear part of the tread of the constant-speed forming wheel are provided respectively with a hot working ridge and a cutting edge, according to the rotational angle.
